(19) United States
(12) Patent Application Publication
(10) Pub. No.: US 2024/0353134 A1
(43) Pub. Date: Oct. 24, 2024

(54) SYSTEM AND METHOD TO CONTROL INDOOR AIR QUALITY IN A MULTI-ZONE ENVIRONMENT

(71) Applicant: Carrier Corporation, Palm Beach Gardens, FL (US)

(72) Inventor: Alex Raj Arulanandan, The Nilgiris (IN)

(21) Appl. No.: 18/627,437

(22) Filed: Apr. 4, 2024

Related U.S. Application Data
(60) Provisional application No. 63/496,904, filed on Apr. 18, 2023.

(51) Int. Cl. F24F 11/49; F24F 11/52; F24F 11/57; F24F 11/65; F24F 11/80; F24F 11/88; F24F 120/20

(52) U.S. Cl. CPC F24F 11/49; F24F 11/52; F24F 11/57; F24F 11/65; F24F 11/88; F24F 11/80; F24F 2120/20; F24F 2221/54

(57) ABSTRACT

A system to control indoor air quality (IAQ) at zones of an area of interest (AOI) is disclosed. The system comprises one or more HVAC devices configured with one or more zones of the AOI, one or more electronic locks configured with a door of the one or more zones, and one or more IAQ sensing devices provided at the one or more zones, wherein the one or more sensing devices are configured to communicatively couple with the one or more electronic locks, and the one or more HVAC devices, and wherein each of the electronic locks is configured to track position and motion of the sensing device that is assigned to the zone where the corresponding electronic lock is installed; and generate an alert signal when the sensing device assigned to any of the one or more zones is detected to be out of the corresponding zone.

### CROSS-REFERENCE TO RELATED APPLICATION

This patent application claims the benefit of U.S. Provisional Patent Application No. 63/496,904, filed on Apr. 18, 2023, which is incorporated by reference herein in its entirety.

### BACKGROUND

This invention relates to the field of heating, ventilation, and air conditioning (HVAC) systems/building management system (BMS) and indoor air quality control, and more particularly, a system and method to control indoor air quality (IAQ) in a multizone environment or zones of an area of interest.

In a multi-zone environment, different HVAC devices may be employed and installed at different zones for independently conditioning the indoor air quality (IAQ) of each zone. Further, an IAQ sensing device may be assigned to and provided at each zone, which may allow users to monitor and adjust the IAQ of the respective zones. The sensing device may communicate with the HVAC device that is in proximity to the sensing device and correspondingly control the operation of the connected HVAC device based on user-defined IAQ levels set by users in the sensing device. However, the sensing device assigned for any specific zone may be mistakenly moved out to any other (unassigned) zone. This may cause the HVAC device of the other zone which is now in communication with the misplaced sensing device, to operate based on the IAQ parameters previously set in the misplaced sensing device, thereby affecting the IAQ levels of the zones.

### SUMMARY

Described herein is a system to control indoor air quality (IAQ) at one or more zones of an area of interest (AOI). The system comprises one or more HVAC devices configured with the one or more zones such that at least one HVAC device is assigned to and fluidically connected to a space associated with each of the zones, one or more electronic locks configured with a door of the one or more zones such that one of the electronic locks is assigned to and installed in the door associated with each of the zones, and one or more IAQ sensing devices provided at the one or more zones such that at least one of the sensing devices is assigned to the space associated with each of the zones, wherein the one or more sensing devices are configured to communicatively couple with the one or more electronic locks, and the one or more HVAC devices, and wherein each of the electronic locks is configured to: track position and motion of the sensing device that is assigned to the zone where the corresponding electronic lock is installed; and generate an alert signal when the sensing device assigned to any of the one or more zones is detected to be out of the corresponding zone.

In one or more embodiments, each of the one or more sensing devices comprises one or more IAQ sensors operable to monitor IAQ of the space associated with the one or more zones where the sensing device is present, an input unit configured to allow a user to set IAQ values to be maintained at the one or more zones, a display unit configured to display the monitored IAQ of the space associated with the one or more zones, and the IAQ values set by the user; a first communication module configured to communicatively couple the corresponding sensing device to the one or more HVAC devices and the one or more electronic locks, and a first one or more processors operatively coupled to the input unit, the display unit, the one or more IAQ sensors, and the first communication module, wherein the first processor enable the sensing device to control the HVAC device that is in communication with the corresponding sensing device, to adjust the IAQ of the corresponding zone at the IAQ values set by the user.

In one or more embodiments, each of the one or more electronic locks comprises a scanning unit operable to scan and extract credentials of the user when the user enters and leaves the corresponding zone where the electronic lock is installed, an actuation unit configured to open and close the door associated with the one or more zones where the electronic lock is installed, a second communication module configured to communicatively couple the corresponding electronic lock to the one or more HVAC devices and the one or more sensing devices, wherein the second communication module is configured to communicate with the first communication module of the one or more sensing devices to facilitate tracking the position and motion of the corresponding sensing device, and a second one or more processors operatively coupled to the scanning unit, the actuation unit, and the second communication module, wherein the second one or more processors are configured to match the scanned credential of the users with a database storing credentials of registered users and correspondingly open the door upon a positive matching.

In one or more embodiments, the first communication module and the second communication module are selected from one or more of a Bluetooth Module, an ultra-wideband (UWB) module, and a WIFI Module.

In one or more embodiments, when the sensing device assigned to any of the one or more zones is detected to be out of the assigned zone, the system is configured to operate the HVAC device of the assigned zone, from where the assigned sensing device is moved out, in a user-defined mode to maintain the IAQ of the corresponding zone at the IAQ values previously set by the user.

In one or more embodiments, when the sensing device assigned to any of the one or more zones is detected to be out of the assigned zone for a predefined time, the system is configured to operate the HVAC device of the assigned zone in a default mode to maintain the IAQ of the corresponding zone at predefined IAQ values.

In one or more embodiments, when the sensing device is detected to be returned within the assigned zone, the system is configured to operate the HVAC device in the user-defined mode.

In one or more embodiments, the system comprises a server in communication with the one or more HVAC devices, and the one or more electronic locks, wherein when the sensing device assigned to any of the one or more zones is detected to be moved out of the assigned zone by the user, the server is configured to identify the user that has moved the sensing device out of the assigned zone, based on the credentials of the user being scanned by the electronic lock while entering or leaving the assigned zone of the sensing device, and generate and transmit the alert signal to one or more mobile devices associated with the identified user, registered security personnel, and/or an admin, wherein the alert signal is indicative of a reminder pertaining to the removal of the sensing device from the assigned zone, and a request to return the sensing device to the assigned zone.

In one or more embodiments, when the sensing device assigned to any of the one or more zones is detected to be moved out of the assigned zone by the user, the server, upon confirmation from the registered security personnel and/or the admin, is configured to actuate the one or more electronic locks to allow the identified user to enter only the assigned zone of the moved sensing device and further lock the remaining electronic locks among the one or more locks to block the identified user from entering the remaining unassigned zones among the one or more zones.

In one or more embodiments, each of the HVAC devices comprises a variable air volume (VAV) in fluidic connection with an air handling unit associated with the AOI, wherein a controller associated with the VAV is in communication with the server, and the electronic lock that is assigned to the zone associated with the VAV, wherein the one or more HVAC devices are configured to maintain the IAQ of the one or more zones at the IAQ values set by the user in the user-defined mode and maintain the IAQ of the one or more zones at the predefined IAQ values in the default mode.

In one or more embodiments, the system is configured to detect a location of the moved sensing devices in the AOI based on a communication between the moved sensing device and the one or more electronic locks in proximity with the moved sensing device, wherein the system is configured to notify the detected location of the moved sensing device over the one or more mobile devices associated with the registered security personnel and/or the admin.

In one or more embodiments, the AOI is a building, and the one or more zones are one or more rooms of the building.

In one or more embodiments, the AOI is a shipment, and the one or more zones are one or more containers associated with the shipment.

Also described herein is a method for controlling indoor air quality (IAQ) at one or more zones of an area of interest (AOI). The method comprises the steps of assigning one or more electronic locks to a door of the one or more zones such that one of the electronic locks is assigned to and installed in the door associated with each of the zones, and assigning one or more IAQ sensing devices to the one or more zones such that at least one of the sensing devices is assigned to and provided at the space associated with each of the zones, wherein the one or more sensing devices are configured to communicatively couple with the one or more electronic locks, and the one or more HVAC devices; tracking, by each of the electronic locks, position, and motion of the sensing device that is assigned to the zone where the corresponding electronic lock is installed; and generating an alert signal when the sensing device assigned to any of the one or more zones is detected to be out of the corresponding zone

In one or more embodiments, when the sensing device assigned to any of the one or more zones is detected to be out of the assigned zone, the method comprises the steps of operating the HVAC device of the assigned zone, from where the assigned sensing device is moved out, in a user-defined mode to maintain the IAQ of the corresponding zone at the IAQ values previously set by the user.

In one or more embodiments, when the sensing device assigned to any of the one or more zones is detected to be out of the assigned zone for a predefined time, the method comprises the steps of operating the HVAC device of the assigned zone in a default mode to maintain the IAQ of the corresponding zone at predefined IAQ values.

In one or more embodiments, when the sensing device is detected to be returned within the assigned zone, the method comprises the steps of operating the HVAC device in the user-defined mode.

In one or more embodiments, the method comprises the steps of scanning and extracting, by the one or more electronic locks, credentials of the user when the user enters and leaves the corresponding zone where the electronic lock is installed; and wherein when the sensing device assigned to any of the one or more zones is detected to be moved out of the assigned zone by the user, the method further comprises the steps of: identifying the user that has moved the sensing device out of the assigned zone, based on the credentials of the user being scanned by the electronic lock while entering or leaving the assigned zone of the sensing device; and generating and transmitting the alert signal to one or more mobile devices associated with the identified user, registered security personnel, and/or an admin, wherein the alert signal is indicative of a reminder pertaining to the removal of the sensing device from the assigned zone, and a request to return the sensing device to the assigned zone.

In one or more embodiments, when the sensing device assigned to any of the one or more zones is detected to be moved out of the assigned zone by the user, the method comprises the steps of actuating the one or more electronic locks, upon confirmation from the registered security personnel and/or the admin, to allow the identified user to enter only the assigned zone of the moved sensing device and further locking the remaining electronic locks among the one or more locks to block the identified user from entering the remaining unassigned zones among the one or more zones.

In one or more embodiments, the method comprises the steps of detecting a location of the moved sensing devices in the AOI based on a communication between the moved sensing device and the one or more electronic locks in proximity to the moved sensing device, and notifying the detected location of the moved sensing device over the one or more mobile devices associated with the registered security personnel and/or the admin.

The foregoing summary is illustrative only and is not intended to be in any way limiting. In addition to the illustrative aspects, embodiments, and features described above, further aspects, embodiments, features, and techniques of the subject disclosure will become more apparent from the following description taken in conjunction with the drawings.

### BRIEF DESCRIPTION OF THE DRAWINGS

The accompanying drawings are included to provide a further understanding of the subject disclosure and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary representation of a system implemented in a multi-zone environment to control the indoor air quality (IAQ) of the zones and further maintain user-defined IAQ at the zones when the sensing devices assigned to the zones are out of place, in accordance with one or more embodiments of the disclosure.

FIG. 2 illustrates exemplary steps involved in a method for maintaining user-defined IAQ in a multi-zone environment when the sensing devices assigned to the zones are out of place, in accordance with one or more embodiments of the disclosure

FIG. 3 illustrates an exemplary control algorithm implemented in the system and method of FIG. 1 and FIG. 2, respectively, in accordance with one or more embodiments of the disclosure.

FIG. 4 illustrates exemplary functional modules of the sensing device, in accordance with one or more embodiments of the disclosure.

FIG. 5 illustrates exemplary functional modules of the electronic lock, in accordance with one or more embodiments of the disclosure

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the subject disclosure, the components of this invention. described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components, respectively, described herein may be oriented in any desired direction.

In a multi-zone environment such as but not limited to a building having multiple floors and multiple rooms, different HVAC devices may be employed and installed at different zones for independently conditioning indoor air quality (IAQ) of each zone, where each HVAC device may be further fluidically connected to an air handling unit. In addition, an IAQ sensing device capable of monitoring different IAQ parameters may be assigned to and provided at each zone. The sensing devices may allow users to monitor as well as set the IAQ level to be maintained at the respective zones. The sensing device may communicate with the HVAC device that is in proximity to the sensing device and correspondingly control the operation of the connected HVAC device based on the user-defined IAQ level set by users in the sensing device.

However, the sensing device assigned for any specific zone may be mistakenly moved out to any other (unassigned) zone. This may cause the HVAC device of the other zone which is now in communication with the misplaced sensing device, to operate based on the IAQ parameters previously set in the misplaced sensing device, thereby affecting the IAQ levels of the zones. For instance, in an example, sensing device A assigned to zone A may be mistakenly placed in another zone B. This may cause the HVAC device of zone B which is now in communication with the misplaced sensing device A, to operate based on the IAQ parameters previously set in the misplaced sensing device A. Thus, there is a need to preserve IAQ levels of zones in a multi-zone environment when the sensing devices assigned to different zones are misplaced or out of place.

This invention provides a simple, efficient, and cost-effective system and method that may be easily configured with the existing HVAC and IAQ control system of any multi-zone environment (area of interest), to control the operation and enhance the efficiency of the HVAC devices while controlling the IAQ at each zone of the environment and further preserving IAQ levels of the zones when the sensing devices assigned to the zones are out of place.

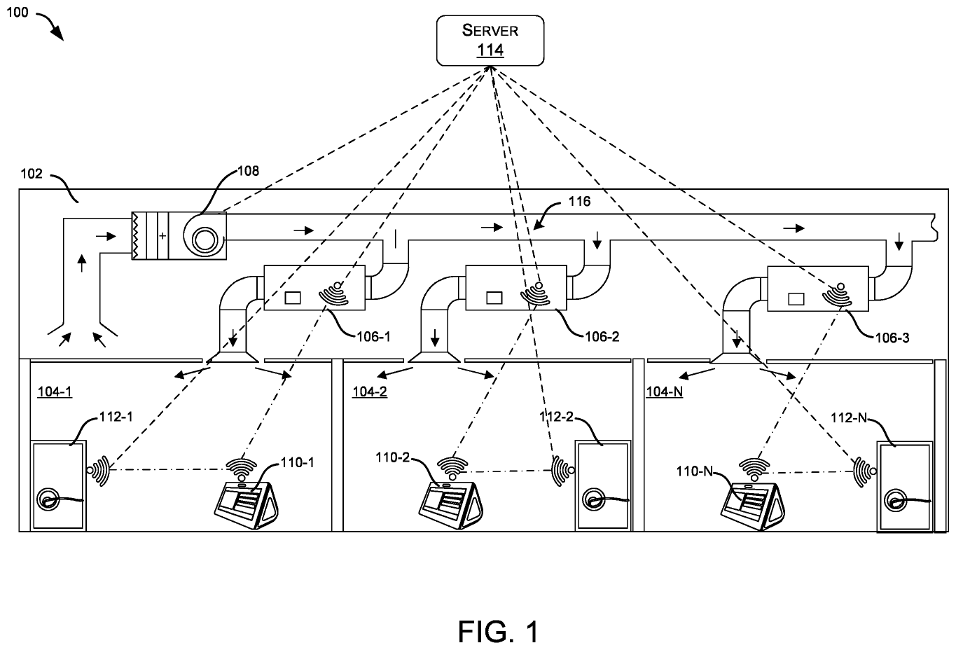

Referring to FIG. 1, a system 100 configured with an HVAC system/building management system (BMS) of a multi-zone environment is disclosed, which is capable of controlling the indoor air quality (IAQ) of the zones while enhancing the efficiency of the HVAC system/BMS and preserving the IAQ of zones when the sensing devices assigned to the zones are out of place. The multi-zone environment 102 (also referred to as an area of interest (AOI), herein) may include a plurality of zones 104-1 to 104-N (collectively referred to as zones 104, herein). In one or more embodiments, the AOI or environment 102 may be a building and the zones 104 may be the rooms of the building 102. In other embodiments, the AOI or environment 102 may be a shipment and the zones 104 may be containers or storage space associated with the shipment 102.

The system 100 may include one or more HVAC devices 106-1 to 106-N (collectively referred to as HVAC devices 106, herein) configured with the zones 104-1 to 104-N such that at least one HVAC device 104 is assigned to and fluidically connected to a space associated with each of the zones 104. Each of the HVAC devices 106 may be further fluidically connected to an air handling unit 108 installed in the AOI 102. Further, the system 100 may include one or more electronic locks 112-1 to 112-N (collectively referred to as electronic locks 112, herein) configured with a door of the zones 104-1 to 104-N such that one of the electronic locks 110 is assigned to and installed in the door associated with each of the zones 104. Furthermore, each zone 104-1 to 104-N may include an indoor air quality (IAQ) sensing device 110-1 to 110-N (collectively referred to as sensing devices 110, herein), to monitor the IAQ of the zones 104-1 to 104-N. The sensing devices 110 may be configured to communicatively couple or communicate with the electronic locks 112 and the HVAC devices 106 through a network. The detailed operation and construction of the AHU 108, the HVAC devices 106, the electronic locks 112, and the sensing device 110 have been described in detail in subsequent paragraphs.

As illustrated, in one or more embodiments, HVAC device 106-1 may be assigned to and installed in zone 104-1, electronic lock 112-2 may be installed in the door of zone 104-1, and sensing device 112-1 may be assigned to and provided in zone 104-1. Further, HVAC device 106-2 may be assigned to and installed in zone 104-2, electronic lock 112-2 may be installed in the door of zone 104-2, and sensing device 110-2 may be assigned to and provided in zone 104-2. Similarly, the N-number of HVAC devices 106-N, electronic device 112-N, and sensing device 110-N may be assigned and installed at the N-number of zones 104-N of the AOI 102. It would be obvious for a person skilled in the art that while various embodiments of the subject disclosure have been elaborated for an AOI having three zones 104-1, 104-2, 104-N, however, teachings of the subject disclosure is applicable to AOI having any number of zones, and all such embodiments are well within the scope of the subject disclosure.

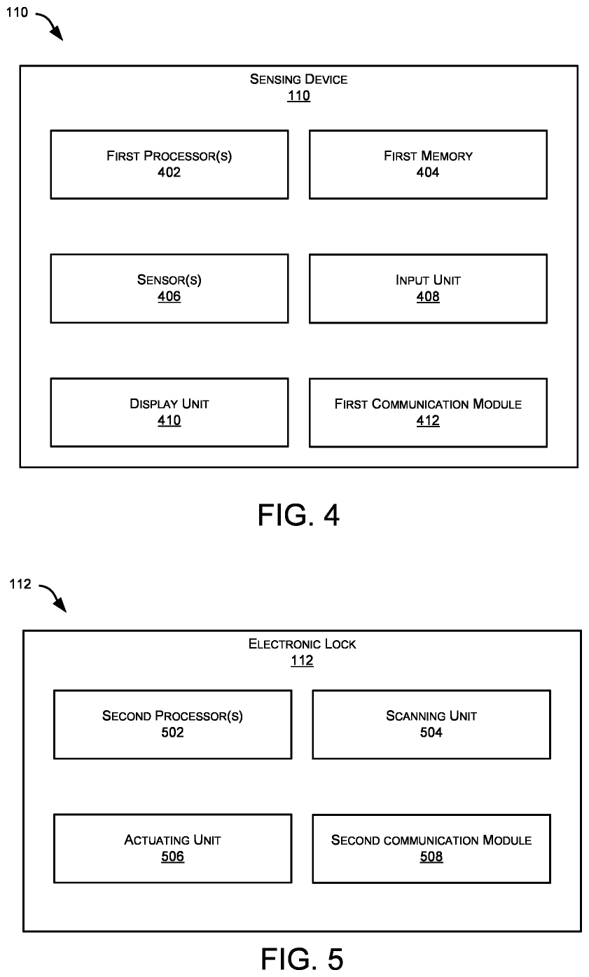

Referring to FIG. 4, the sensing device 110 may include one or more IAQ sensors 406 operable to monitor the levels of temperature, humidity, carbon monoxide (CO), carbon dioxide (CO₂), particulate matter, total volatile compounds (TVOCs), carcinogenic formaldehyde, bacteria, but not limited to the like, present in the zones 104 where the sensing device 110 is present. The sensing device 110 may include an input unit 408 such as a keyboard or buttons that may allow users to monitor as well as set the IAQ level to be maintained at the respective zones. Further, the sensing device 110 may include a display unit 410 configured to display the monitored IAQ of the space associated with the zones 104, and the IAQ values set by the user. In one or more embodiments, the display unit 410 may be a touch screen that may act as the input unit as well as a display. Furthermore, the sensing device 110 may include a first communication module 412 that may enable the sensing device 110 to communicate with the HVAC device 106 that is in proximity to the sensing device 110 and may further include a first one or more processors 402 and a first memory 402 operatively coupled to the input unit 408, the display unit 410, the IAQ sensors 406, and the first communication module 412, which may control the operation of the connected HVAC device 106 based on the user-defined IAQ level set by users in the sensing device 110.

Referring to FIG. 4, the electronic lock 112 may include a scanning unit 504 operable to scan or extract credentials of the user when the user enters and leaves the corresponding zone 104 where the electronic lock 112 is installed. The credentials may be details and biometric signatures of the users, a unique password, and the like. The scanning unit may include a camera, an RFID reader, an optical scanner, or a biometric device, but is not limited to the like. The electronic lock 112 may further include an actuation 506 unit comprising actuators that are known in the art. The actuation unit 506 may be configured to open and close the door associated with the zones 104 where the electronic lock 112 is installed. Further, the electronic lock 112 may include a second communication module 508 configured to communicatively couple the corresponding electronic lock 112 to the HVAC devices 106 and the sensing devices 110. The second communication module 508 may enable the electronic lock 112 to communicate with the first communication module 412 of the sensing devices 110 to facilitate tracking the position and motion of the corresponding sensing device 110. Furthermore, the electronic lock 112 may include a second one or more processors 502 operatively coupled to the scanning unit 504, the actuation unit 506, and the second communication module 508. The second one or more processors 502 may enable the electronic lock 112 to match the scanned credential of the users with a database storing credentials of registered users and correspondingly open the door upon a positive matching or keep the door locked upon a negative matching. In one or more embodiments, the first communication module 412 and the second communication module 508 may be selected from one or more of a Bluetooth Module, an ultra-wideband (UWB) module, a WIFI Module, and the like.

The HVAC system/BMS or AHU 108 may include a duct system 116 comprising a supply air stream duct comprising a plurality of interconnected supply channels fluidically connected to each zone 104 via the HVAC devices 106 to facilitate the inflow of supply air into the zones 104 of the AOI 102 after getting conditioned by the corresponding HVAC device 106, and a return air duct comprising a plurality of interconnected return channels to facilitate outflow of return air from each of the zones 104. The HVAC system/BMS or AHU 108 may further include a central damper configured to regulate the flow of supply air comprising any or a mixture of outside air and the return air into the supply airstream duct. A plurality of zone dampers may be installed in the plurality of interconnected supply channels such that one of the zone dampers is configured in each of the supply channels for individually regulating the flow of supply air into each zone 104 via the HVAC device 106. The AHU 108 or each HVAC device 106 may include a cooling unit, a heating unit, a set of filters, a dehumidification unit, a fan assembly, and the like, which may facilitate in conditioning the quality of the air being supplied to the respective zones 104. In one or more embodiments, the HVAC device 106 may comprise a variable air volume (VAV) (also designated as 106, herein) that is in fluidic connection with the AOI 102 through the supply channels and the return channels. Further, a controller associated with the VAV/HVAC device 106 can be in communication with the electronic lock 112 that is assigned to the zone 104 associated with the VAV. Furthermore, the controller associated with the VAV/HVAC device 106 can also be in communication with the sensing device 110 which is in proximity to the VAV.

In one or more embodiments, each of the VAVs/HVAC devices 106 and each of the electronic locks 112 may be in communication with a central server 114. However, in other embodiments, each of the VAVs/HVAC devices 106 may be in communication with a first server associated with the HVAC system/BMS of the AOI 102 and each of the electronic locks 112 may be in communication with a second server associated with a security system 100 of the AOI 102. Further, the first server may be in communication with the second server or a common central server. The first server, the second server, or the central server may be collectively designated as server, herein).

The server 114 can be configured to be operatively connected to the AHU 108, the dampers, the HVAC devices 106, as well as the electronic locks 112, and other components of the system 100 to control the operation of the HVAC system/BMS and the security system of the AOI 102. The server 114 may include a processing device coupled to a memory device storing instructions executable by the processing device to enable the server 114 to perform one or more designated operations.

In one or more embodiments, the system 100 or server 114 can be operatively coupled to a website and so be operable from any Internet-enabled user device or mobile device. Examples of user devices or mobile may include but are not limited to, a portable computer, a personal digital assistant, a handheld device, and a workstation. The sensing devices 110, the electronic locks 112, and the HVAC device 106 may be in communication with each other and with the server 114 through a network via wired and/or wireless media.

In one implementation, the network can be a wireless network, a wired network or a combination thereof. Network can be implemented as one of the different types of networks, such as intranet, local area network (LAN), wide area network (WAN), the internet, and the like. Further, the network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, network can include a variety of network devices, including transceivers, routers, bridges, server s, computing devices, storage devices, and the like. In another implementation the network can be a cellular network or mobile communication network based on various technologies, including but not limited to, Global System 100 for Mobile (GSM), General Packet Radio Service (GPRS), Code Division Multiple Access (CDMA), Long Term Evolution (LTE), WiMAX, 5G or 6G network protocols, and the like.

In one or more embodiments, each of the electronic locks 112 may track the position and motion of the sensing device 110 that is assigned to the zone 104 where the corresponding electronic lock 112 is installed. The electronic locks 112 may further generate an alert signal when the sensing device 110 assigned to any of the zones 104 is detected to be out (or moved out) of the corresponding zone 104. The alert signal may be transmitted to the server 114 and one or more mobile devices associated with the user who has misplaced the sensing device 110, registered security personnel, and/or an admin. The alert signal may be indicative of a reminder on the removal of the sensing device 110 from the assigned zone 104, and a request or reminder to return the sensing device 110 to the assigned zone 104

In one or more embodiments, when the electronic lock 112 detects the sensing device 110 to be misplaced or out of its assigned zone 104, the electronic lock 112 may notify the server 114 that may further operate the HVAC device 106 of the zone 104 (from where the assigned sensing device 110 is moved out) in a user-defined mode. In the user-defined mode, the HVAC device 106 and AHU 108 may facilitate maintaining the IAQ of the corresponding zone 104 at the IAQ values previously set by the user before the misplacement of the sensing device 110.

Further, when the electronic lock 112 detects the sensing device 110 to be out of its assigned zone 104 for a predefined time, the electronic lock 112 may notify the server 114 that may further operate the HVAC device 106 of the assigned zone 104 in a default mode where the HVAC device 106 maintains the IAQ of the corresponding zone 104 at predefined IAQ values. In an example, the predefined IAQ values may include 75° Fahrenheit temperature or room temperature but is not limited to the like. However, when the sensing device 110 is detected to be returned within its assigned zone 104, the server 114 may be configured to re-operate the HVAC device 106 in the user-defined mode.

In one or more embodiments, when the electronic locks 112 detect the sensing devices 110 to be moved out of their assigned zone 104 by the user, the electronic lock 112 may identify the user who has moved the sensing device 110 out of the assigned zone 104, based on the credentials of the user being scanned by the electronic lock 112 while entering or leaving the assigned zone 104 of the sensing device 110. The electronic locks 112 may further generate and transmit the alert signal to the server 114, and the mobile devices associated with the identified user, registered security personnel, and/or an admin. The alert signal may be indicative of a reminder on the removal of the sensing device 110 from the assigned zone 104, and a request or reminder to return the sensing device 110 to the assigned zone 104.

Further, when the sensing device 110 is detected to be moved out of the assigned zone 104 by the user, the server 114, upon confirmation from the registered security personnel and/or the admin, may be configured to actuate all the electronic locks 112 associated with the AOI 102 to allow the identified user to enter only the assigned zone 104 of the moved sensing device 110 and further lock the remaining electronic locks 112 to block the identified user from entering the remaining unassigned zones 104. This may prevent the user from placing the misplaced sensing device 110 in any other unassigned zone 104, which may further restrict the HVAC devices 106 of remaining unassigned zones 104 to operate as per the misplaced sensing device 110.

In an example, if the electronic lock 112-1 of zone 104-1 detects the sensing device 110-1 (that is assigned to zone 104-1) to be taken out of zone 104-1 by a user, the electronic lock 112-1 may identify the user based on his/her credential scanned at the time of entering or leaving the zone 104-1. The electronic lock 112-1 may further generate and transmit an alert signal to the server 114 and mobile devices of the identified user, the registered security personnel, and/or an admin. The alert signal may be a reminder for the identified user which may pertain to the removal of the sensing device 110-1 from the assigned zone 104-1, and a request to return the sensing device 110-1 to the assigned zone 104-1. However, if the identified user fails to return the misplaced sensing device 110-1 back to zone 104-1 or if the identified user is found to be an unauthorized user, the server 114 upon confirmation from the admin or registered security personnel may actuate the electronic lock 112-1 to allow the identified user to enter only the zone 104-1 and further lock the remaining electronic lock 112-1 to 112-N to block the identified user from entering the unassigned zones 104-2 to 104-N.

In one or more embodiments, the server 114 may be configured to detect the location of the moved sensing devices 110 in the AOI 102 based on communication between the moved sensing device 110 and the electronic locks 112 that are in proximity to the moved sensing device 110. The system 100 may be configured to notify the detected location of the moved sensing device 110 over the mobile devices associated with the registered security personnel and/or the admin, which may help in restoring the misplaced sensing device 110 to its assigned zone 104.

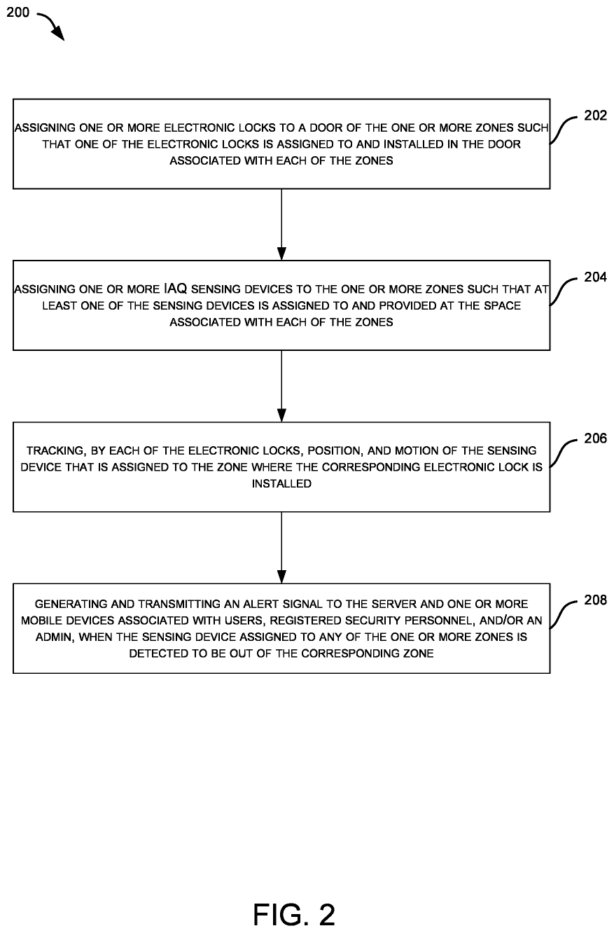

Referring to FIG. 2, method 200 for controlling the operation and enhancing the efficiency of the HVAC system/BMS in a multi-zone environment or AOI is disclosed, which controls indoor air quality (IAQ) at the zones and further preserves the IAQ of zones when the sensing device assigned to any of the zones is found to be out of place. Method 300 may involve the AHU 108, HVAC devices 106, electronic locks 112, sensing devices 110, server 114, and other components associated with the system 100 of FIG. 1. Method 200 may include step 202 of assigning one or more electronic locks 112-1 to 112-N to a door of the one or more zones 104-1 to 104-N such that one of the electronic locks 112 is assigned to and installed in the door associated with each of the zones 104. Method 200 may further include step 204 of assigning one or more IAQ sensing devices 110-1 to 110-N to the one or more zones 104-1 to 104-N such that at least one of the sensing devices 110 is assigned to and provided at the space associated with each of the zones 104. The sensing devices 110 may be configured to communicatively couple with the electronic locks 112, and the HVAC devices 106.

Method 200 may further include step 206 of tracking, by each of the electronic locks 112, position and motion of the sensing device 110 that is assigned to the zone 104 where the corresponding electronic lock 112 is installed. Further, when the sensing device 110 assigned to any of the one or more zones 104 is detected to be out of the corresponding zone 104, method 200 may include step 208 of generating and transmitting an alert signal to the server 114 and one or more mobile devices associated with users, registered security personnel, and/or an admin. The alert signal is may be indicative of a reminder on the removal of the sensing device 110 from the assigned zone 104, and a request or reminder to return the sensing device 110 to the assigned zone 104.

In one or more embodiments, when the sensing device 110 assigned to any of the one zone 104 is detected to be out of their assigned zone 104, method 200 may include the steps of operating the HVAC device 106 of the assigned zone 104 (from where the assigned sensing device 110 is moved out) in a user-defined mode where the HVAC device 106 maintain the IAQ of the corresponding zone 104 at the IAQ values previously set by the user.

Further, when the sensing device 110 is detected to be out of the assigned zone 104 for a predefined time, method 200 may include the steps of operating the HVAC device 106 of the assigned zone 104 in a default mode where the HVAC device 106 maintains the IAQ of the corresponding zone 104 at predefined IAQ values. Furthermore, when the sensing device 110 is detected to be returned within the assigned zone 104, method 200 may include the steps of switching the HVAC device 106 from the default mode to the user-defined mode.

In one or more embodiments, method 200 may include steps of scanning and extracting, by the electronic locks 112, credentials of the user when the user enters and leaves the corresponding zone 104 where the electronic lock 112 is installed. Further, when the sensing device 110 assigned to any of the zones 104 is detected to be moved out of the assigned zone 104 by the user, method 200 may further include the steps of identifying the user that has moved the sensing device 110 out of the assigned zone 104, based on the credentials of the user being scanned by the electronic lock 112 while entering or leaving the assigned zone 104 of the sensing device 110, and further generating and transmitting the alert signal to the server 114 and the mobile devices associated with the identified user, registered security personnel, and/or the admin.

In one or more embodiments, when the sensing device 110 assigned to any of the one or more zones 104 is detected to be moved out of the assigned zone 104 by the user, method 200 may include steps of actuating the electronic locks 112, upon confirmation from the registered security personnel and/or the admin, to allow the identified user to enter only the assigned zone 104 of the moved sensing device 110 and further locking the remaining electronic locks 112 to block the identified user from entering the remaining unassigned zones 104.

In one or more embodiments, method 200 may include the steps of detecting the location of the moved sensing devices 110 in the AOI 102 based on a communication between the moved sensing device 110 and the electronic locks 112 in proximity with the moved sensing device 110, further notifying the detected location of the moved sensing device 110 over the server 114 and mobile devices associated with the registered security personnel and/or the admin.

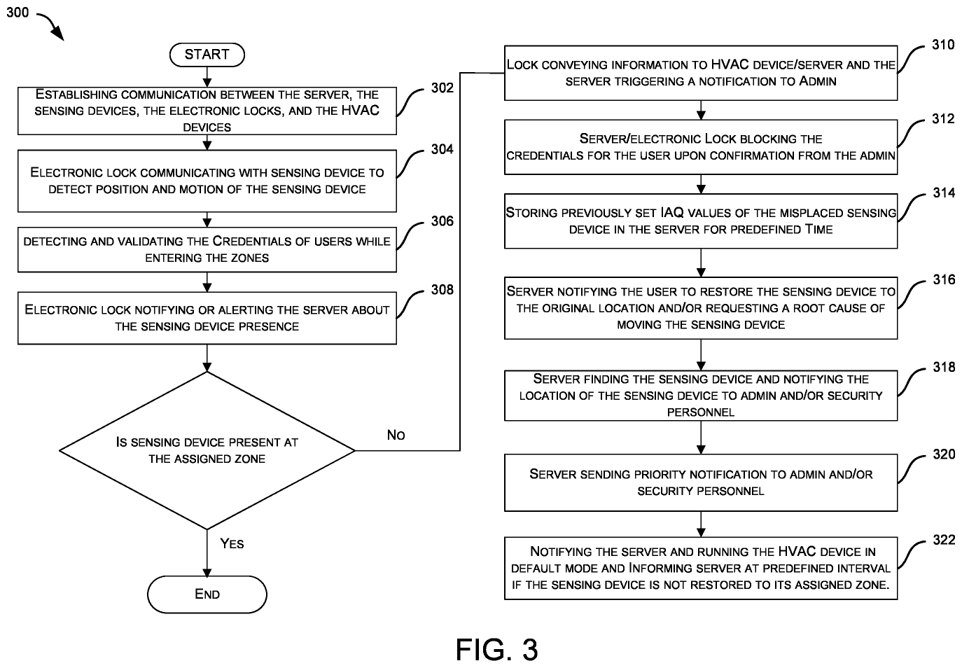

Referring to FIG. 3, in one or more embodiments, a control strategy 300 for implementing the system 100 of FIG. 1 and the method of FIG. 2 is disclosed. As illustrated, once the HVAC devices 106, electronic locks 112, and electronic locks 112 are assigned to different zones 104 of the AOI 102, at block 302, the communication modules associated with the electronic locks 112, the sensing devices 110, and the HVAC devices 106 may be activated to establish communication therebetween. Further, at block 304, the electronic locks 112 may communicate with the sensing devices 110 that are assigned to the respective zone 104 or in proximity to the electronic locks 112, to detect the position and movement of the assigned sensing devices 110 as well as the sensing devices 110 that are in the network range of the electronic locks 112.

At block 306, the electronic locks 112 may detect and extract the credentials of users while entering the respective zone 104 and may further validate the credentials and provide access to the zones 104 upon validation. Further, at block 308, the electronic locks 112 may notify the server 114 about the presence of the sensing devices 110 assigned to the respective zones 104. In one or more embodiments, if the sensing devices 110 are detected to be within their assigned zone 104, the server 114 may operate the HVAC device 106 of the respective room in the user-defined mode, based on the IAQ levels set by the user in the sensing device 110.

In one or more embodiments, if the sensing devices 110 are detected to be out of their assigned zone 104, at block 310, the electronic lock 112 may notify the registered security personnel and admin associated with the system 100. Further, at block 312, the electronic locks 112 or the server 114 may block the credentials of the user that has moved the sensing device 110 (upon confirmation from the admin) and may further restrict the identified user from entering the remaining zones 104. At block 314, the server 114 may store the IAQ values previously set in the misplaced sensing device 110 and correspondingly operate the HVAC device 106 at the previously set IAQ values for a predefined time. Furthermore, at block 316, the server 114 may notify or alert the user that has moved the sensing device 110, to restore the misplaced sensing device 110 at its assigned zone 104 or request a reason for moving the sensing device 110 out of its assigned zone 104.

In one or more embodiments, at block 318, the server 114 may find the real-time location of the misplaced sensing device 110 in the AOI 102 based on communication between the electronic locks 112 that are in proximity to the misplaced sensing device 110, and may further notify the location of the misplaced sensing device 110 to the admin and/or registered security personnel.

In one or more embodiments, at block 320, the server 114 may generate and transmit a priority notification to the mobile devices of the admin, and/or security personnel to restore the misplaced sensing device 110 to its assigned zone 104 within the predefined time. If the misplaced sensing device 110 is not restored to its assigned zone 104 within the predefined time, at block 322, the server 114 may actuate the HVAC device 106 of the assigned zone 104 to operate in the default mode.

In one or more embodiments, the air handling unit (AHU) 108 employed in system 100 and method 200 may be used to regulate and circulate air within the zones 104 of the AOI 102. AHU 108 may be a part of a larger heating, ventilation, and air conditioning system of the AOI 102, which may be connected to the HVAC devices/VAVs 106 assigned to each zone 104. The AHU 108 is the composition of elements mounted in large, accessible box-shaped units installed at the AOI 102, which may be responsible for conditioning the supply air to ensure that the supply air is at the desired temperature, humidity, and air quality. The AHU 108 may include blowers, filters, heating or cooling coils, humidifiers or dehumidifiers, heat exchangers, a mixing chamber, and the like. The blower or fan may be responsible for moving air through the AHU 108 and HVAC devices 106, while the filter may remove dust, pollen, and other contaminants from the outside air or return air. Filters depending on the air purity requirements may be selected to provide a higher or lower particle, viruses, bacteria, odor, and other air pollutants retention. The heating or cooling coils may be used to adjust the temperature of the supply air, while the humidifiers and dehumidifiers control the moisture content of the air to be supplied to the zones 104. The mixing chamber may facilitate the air to be homogenized by facilitating the mixing of fresh outside air with the return air to achieve the desired air quality and temperature. The heat exchanger device may transfer temperature between two fluids, in this case, coolant and the air, separated by solid barriers.

Thus, in addition to managing the proper ventilation at the zones with the air, the AHU 108 may perform other functions such as but not limited to filtration and control of the quality of the air that may reach the zones 104, and control of the air temperature that regulates the air conditioning system in cold or hot, so that the IAQ values in the zones 104 is in a desirable or user-defined range. The AHU 108 may further monitor and control the relative humidity for greater indoor comfort in the zones 104.

In one or more embodiments, the sensors 406 of the sensing device 110 employed in the system 100 and method 200 may be a carbon monoxide (CO) sensor, a carbon dioxide sensor (CO₂), a volatile organic compound (VOC) sensor, a carcinogenic formaldehyde sensor, or particulate sensor, but not limited to the like. The captured IAQ data of the zones 104 may then be transmitted to the server 114 or controller of the AHU or HVAC device via a transceiver for further processing as already explained in detail in FIG. 1. In one or more embodiments, all the sensors 406 can be positioned over a single frame that can be installed as a stand-alone device in different zones 104 of the AOI 102. In some embodiments, the sensors 406 can be distributed at different positions within the zones 104 of the AOI 102. The distributed sensors 406 can be operatively connected in a mesh network where a master sensor among the sensors 406 may be in communication with the server 114 or HVAC device/VAV via wired media or wireless media. In other embodiments, the sensors 406 can also be integrated with smoke sensors installed within the zones of the AOI, wherein the smoke detector/IAQ sensors may be in communication with the server 114 or HVAC device via wired media or wireless media.

Thus, the invention provides a simple, efficient, and cost-effective system and method that may be easily configured with the existing HVAC and IAQ control system of any multi-zone environment (area of interest), and may control the operation and enhance the efficiency of the HVAC devices while controlling the IAQ at each zone of the environment and further preserving IAQ levels of the zones when the sensing devices assigned to the zones are out of place.

It is to be appreciated by a person skilled in the art that while various embodiments of the subject disclosure elaborate upon detecting the position or movement of the sensing device based on a communication established between the sensing devices 110 and the electronic locks 112 installed at the zones or AOI, however, the position or movement of the sensing device 110 may also be detected based on a communication between the sensing devices 110 and any smart device such as a smart air purifier, and the like present at the zones 104, and all such embodiments are well within the scope of the subject disclosure.

While the subject disclosure has been described with reference to exemplary embodiments, it will be understood by those skilled in the art that various changes may be made and equivalents may be substituted for elements thereof without departing from the scope of the subject disclosure as defined by the appended claims. Modifications may be made to adopt a particular situation or material to the teachings of the subject disclosure without departing from the scope thereof. Therefore, it is intended that the subject disclosure not be limited to the particular embodiment disclosed, but that the subject disclosure includes all embodiments falling within the scope of the subject disclosure as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. A system to control indoor air quality (IAQ) at one or more zones of an area of interest (AOI), the system comprising:
one or more HVAC devices configured with the one or more zones such that at least one HVAC device is assigned to and fluidically connected to a space associated with each of the zones;
one or more electronic locks configured with a door of the one or more zones such that one of the electronic locks is assigned to and installed in the door associated with each of the zones; and
one or more IAQ sensing devices provided at the one or more zones such that at least one of the sensing devices is assigned to the space associated with each of the zones; wherein the one or more sensing devices are configured to communicatively couple with the one or more electronic locks, and the one or more HVAC devices, and
wherein each of the electronic locks is configured to:
track position and motion of the sensing device that is assigned to the zone where the corresponding electronic lock is installed; and
generate an alert signal when the sensing device assigned to any of the one or more zones is detected to be out of the corresponding zone.

2. The system of claim 1, wherein each of the one or more sensing devices comprises:
one or more IAQ sensors operable to monitor IAQ of the space associated with the one or more zones where the sensing device is present;
an input unit configured to allow a user to set IAQ values to be maintained at the one or more zones;
a display unit configured to display the monitored IAQ of the space associated with the one or more zones, and the IAQ values set by the user;
a first communication module configured to communicatively couple the corresponding sensing device to the one or more HVAC devices and the one or more electronic locks; and
a first one or more processors operatively coupled to the input unit, the display unit, the one or more IAQ sensors, and the first communication module, wherein the first one or more processor enable the sensing device to control the HVAC device that is in communication with the corresponding sensing device, to adjust the IAQ of the corresponding zone at the IAQ values set by the user.

3. The system of claim 1, wherein each of the one or more electronic locks comprises:
a scanning unit operable to scan and extract credentials of the user when the user enters and leaves the corresponding zone where the electronic lock is installed;
an actuation unit configured to open and close the door associated with the one or more zones where the electronic lock is installed;
a second communication module configured to communicatively couple the corresponding electronic lock to the one or more HVAC devices and the one or more sensing devices,
wherein the second communication module is configured to communicate with the first communication module of the one or more sensing devices to facilitate tracking the position and motion of the corresponding sensing device; and
a second one or more processors operatively coupled to the scanning unit, the actuation unit, and the second communication module, wherein the second one or more processors are configured to match the scanned credential of the users with a database storing credentials of registered users and correspondingly open the door upon a positive matching.

4. The system of claim 3, wherein the first communication module and the second communication module are selected from one or more of a Bluetooth Module, an ultra-wideband (UWB) module, and a WIFI Module.

5. The system of claim 1, wherein when the sensing device assigned to any of the one or more zones is detected to be out of the assigned zone, the system is configured to operate the HVAC device of the assigned zone, from where the assigned sensing device is moved out, in a user-defined mode to maintain the IAQ of the corresponding zone at the IAQ values previously set by the user.

6. The system of claim 5, wherein when the sensing device assigned to any of the one or more zones is detected to be out of the assigned zone for a predefined time, the system is configured to operate the HVAC device of the assigned zone in a default mode to maintain the IAQ of the corresponding zone at predefined IAQ values.

7. The system of claim 5, wherein when the sensing device is detected to be returned within the assigned zone, the system is configured to operate the HVAC device in the user-defined mode.

8. The system of claim 1, wherein the system comprises:
a server in communication with the one or more HVAC devices, and the one or more electronic locks,
wherein when the sensing device assigned to any of the one or more zones is detected to be moved out of the assigned zone by the user, the server is configured to:
identify the user that has moved the sensing device out of the assigned zone, based on the credentials of the user being scanned by the electronic lock while entering or leaving the assigned zone of the sensing device; and
generate and transmit the alert signal to one or more mobile devices associated with the identified user, registered security personnel, and/or an admin, wherein the alert signal is indicative of a reminder pertaining to the removal of the sensing device from the assigned zone, and a request to return the sensing device to the assigned zone.

9. The system of claim 1, wherein when the sensing device assigned to any of the one or more zones is detected to be moved out of the assigned zone by the user, the server, upon confirmation from the registered security personnel and/or the admin, is configured to:
actuate the one or more electronic locks to allow the identified user to enter only the assigned zone of the moved sensing device and further lock the remaining electronic locks among the one or more locks to block the identified user from entering the remaining unassigned zones among the one or more zones.

10. The system of claim 1, wherein each of the HVAC devices comprises a variable air volume (VAV) in fluidic connection with an air handling unit associated with the AOI, wherein a controller associated with the VAV is in communication with the server, and the electronic lock that is assigned to the zone associated with the VAV,
wherein the one or more HVAC devices are configured to:
maintain the IAQ of the one or more zones at the IAQ values set by the user in the user-defined mode; and
maintain the IAQ of the one or more zones at the predefined IAQ values in the default mode.

11. The system of claim 1, wherein the system is configured to detect a location of the moved sensing devices in the AOI based on a communication between the moved sensing device and the one or more electronic locks in proximity with the moved sensing device, wherein the system is configured to notify the detected location of the moved sensing device over the one or more mobile devices associated with the registered security personnel and/or the admin.

12. The system of claim 1, wherein the AOI is a building, and the one or more zones are one or more rooms of the building.

13. The system of claim 1, wherein the AOI is a shipment, and the one or more zones are one or more containers associated with the shipment.

14. A method for controlling indoor air quality (IAQ) at one or more zones of an area of interest (AOI), the method comprising the steps of:
assigning one or more electronic locks to a door of the one or more zones such that one of the electronic locks is assigned to and installed in the door associated with each of the zones; and
assigning one or more IAQ sensing devices to the one or more zones such that at least one of the sensing devices is assigned to and provided at the space associated with each of the zones; wherein the one or more sensing devices are configured to communicatively couple with the one or more electronic locks, and the one or more HVAC devices;
tracking, by each of the electronic locks, position and motion of the sensing device that is assigned to the zone where the corresponding electronic lock is installed; and
generating an alert signal when the sensing device assigned to any of the one or more zones is detected to be out of the corresponding zone.

15. The method of claim 14, wherein when the sensing device assigned to any of the one or more zones is detected to be out of the assigned zone, the method comprises the steps of operating the HVAC device of the assigned zone, from where the assigned sensing device is moved out, in a user-defined mode to maintain the IAQ of the corresponding zone at the IAQ values previously set by the user.

16. The method of 15, wherein when the sensing device assigned to any of the one or more zones is detected to be out of the assigned zone for a predefined time, the method comprises the steps of operating the HVAC device of the assigned zone in a default mode to maintain the IAQ of the corresponding zone at predefined IAQ values.

17. The method of claim 16, wherein when the sensing device is detected to be returned within the assigned zone, the method comprises the steps of operating the HVAC device in the user-defined mode.

18. The method of claim 14, wherein the method comprises the steps of scanning and extracting, by the one or more electronic locks, credentials of the user when the user enters and leaves the corresponding zone where the electronic lock is installed; and
wherein when the sensing device assigned to any of the one or more zones is detected to be moved out of the assigned zone by the user, the method further comprises the steps of:
identifying the user that has moved the sensing device out of the assigned zone, based on the credentials of the user being scanned by the electronic lock while entering or leaving the assigned zone of the sensing device; and
generating and transmitting the alert signal to one or more mobile devices associated with the identified user, registered security personnel, and/or an admin, wherein the alert signal is indicative of a reminder pertaining to the removal of the sensing device from the assigned zone, and a request to return the sensing device to the assigned zone.

19. The method of claim 14, wherein when the sensing device assigned to any of the one or more zones is detected to be moved out of the assigned zone by the user, the method comprises the steps of:
actuating the one or more electronic locks, upon confirmation from the registered security personnel and/or the admin, to allow the identified user to enter only the assigned zone of the moved sensing device and further locking the remaining electronic locks among the one or more locks to block the identified user from entering the remaining unassigned zones among the one or more zones.

20. The method of claim 14, wherein the method comprises the steps of:
detecting a location of the moved sensing devices in the AOI based on a communication between the moved sensing device and the one or more electronic locks in proximity to the moved sensing device; and
notifying the detected location of the moved sensing device over the one or more mobile devices associated with the registered security personnel and/or the admin.
